(19) United States
(12) Patent Application Publication
(10) Pub. No.: US 2003/0048226 A1
(43) Pub. Date: Mar. 13, 2003

(54) Antenna for array applications

(75) Inventors: Griffin K. Gothard, Satellite Beach, FL (US); Bing Chiang, Melbourne, FL (US); Christopher A. Snyder, Palm Bay, FL (US); Kenneth M. Gainey, Satellite Beach, FL (US); James A. Proctor JR., Indialantic, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tantivy Communications, Inc., Melbourne, FL

(21) Appl. No.: 10/146,501

(22) Filed: May 14, 2002

Related U.S. Application Data
(63) Continuation-in-part of application No. 09/773,251, filed on Jan. 31, 2001, now Pat. No. 6,417,806.
(63) Continuation-in-part of application No. 09/773,277, filed on Jan. 31, 2001, now Pat. No. 6,396,456.

(51) Int. Cl. H01Q 1/48; H01Q 21/00

(52) U.S. Cl. 343/700 MS; 343/846; 343/893

(57) ABSTRACT

An antenna with a first conductive element positioned in an lower region of the antenna, and a second conductive element positioned above the first conductive element in an upper region of the antenna. One of the conductive elements is an active element that transmits and receives signals, while the other element is a ground element.

### RELATED APPLICATIONS

This application is a continuation-in-part of U.S. application Ser. No. 09/773,251, filed Jan. 31, 2001, and U.S. application Ser. No. 09/773,277, filed Jan. 31, 2001. The entire teachings of the above applications are incorporated herein by reference.

### BACKGROUND OF THE INVENTION

Code Division Multiple Access (CDMA) communication systems may be used to provide wireless communication between a base station and one or more subscriber units. The base station is typically a computer controlled set of switching transceivers that are interconnected to a land-based public switched telephone network (PSTN). The base station includes an antenna apparatus for sending forward link radio frequency signals to the mobile subscriber units. The base station antenna is also responsible for receiving reverse link radio frequency signals transmitted from each mobile unit. Each mobile subscriber unit also contains an antenna apparatus for the reception of the forward link signals and for transmission of the reverse link signals. A typical mobile subscriber unit is a digital cellular telephone handset or a personal computer coupled to a wireless cellular modem.

The most common type of antenna used to transmit and receive signals at a mobile subscriber unit is an omni-directional monopole antenna. This type of antenna consists of a single wire or antenna element that is coupled to a transceiver within the subscriber unit. The transceiver receives reverse link signals to be transmitted from circuitry within the subscriber unit and modulates the signals onto the antenna element at a specified frequency assigned to that subscriber unit. Forward link signals received by the antenna element at a specified frequency are demodulated by the transceiver and supplied to processing circuitry within the subscriber unit. In CDMA cellular systems, multiple mobile subscriber units may transmit and receive signals on the same frequency and use coding algorithms to detect signaling information intended for individual subscriber units on a per unit basis.

The transmitted signal sent from a monopole antenna is omnidirectional in nature. That is, the signal is sent with the same signal strength in all directions in a generally horizontal plane. Reception of signals with a monopole antenna element is likewise omnidirectional. A monopole antenna does not differentiate in its ability to detect a signal on one direction versus detection of the same or a different signal coming from another direction.

### SUMMARY OF THE INVENTION

Various problems are inherent in prior art antennas used on mobile subscriber units in wireless communications systems. Typically, an antenna array with scanning capabilities consists of a number of antenna elements located on top of a ground plane. For the subscriber unit to satisfy portability requirements, the ground plane must be physically small. For example, in cellular communication applications, the ground plane is typically smaller than the wavelength of the transmitted and received signals. Because of the interaction between the small ground plane and the antenna elements, which are typically monopole elements, the peak strength of the beam formed by the array is elevated above the horizon, for example, by about 30°, even though the beam itself is directed along the horizon. Correspondingly the strength of the beam along the horizon is about 3 db less than the peak strength. Generally, the subscriber units are located at large distances from the base stations such that the angle of incidence between the subscriber unit and the base station is approximately zero. The ground plane would have to be significantly larger than the wavelength of the transmitted/received signals to be able to bring the peak beam down towards the horizon. For example, in an 800 Mhz system, the ground plane would have to be significantly larger than 14 inches in diameter, and in a PCS system operating at about 1900 Mhz, the ground plane would have to be significantly larger than about 6.5 inches in diameter. Ground planes with such large sizes would prohibit using the subscriber unit as a portable device. It is desirable, therefore, to direct the peak strength of the beam along the horizon with antenna elements mounted on a small ground plane so that the subscriber unit is mobile. Further, it is desirable to produce antenna elements with these beam directing features using low-cost mass production techniques.

The present invention greatly reduces problems encountered by the aforementioned prior art antenna systems. The present invention provides an inexpensive antenna for use with a mobile subscriber unit in a wireless same frequency network communications system, such as CDMA cellular communication networks. The antenna can be fabricated with printed circuit board (PCB) photo-etching techniques for precise control of the printed structure.

In one aspect, the present invention provides an antenna with a first conductive element positioned in an lower region of the antenna, and a second conductive element positioned above the first conductive element in an upper region of the antenna. One of the conductive elements is an active element that transmits and receives signals, while the other element is a ground element.

Embodiments of this aspect can include one or more of the following features. In some embodiments, the first conductive element is the ground element, and the second conductive element can include a center feed coupled to a feed strip for facilitating coupling the antenna to a transmission line. In other embodiments, the second conductive element is the ground element, and the first conductive element can include an end feed.

The ground element can be coupled a ground surface. The ground surface can be planar. The planar ground surface can be positioned substantially parallel, or perpendicular, to the first and second conductive elements. Alternatively or additionally, the first and second conductive elements can be planar.

In particular embodiments, the ground surface has a conical shape with the apex of the conical surface positioned proximate to the ground and active elements and the base of the surface positioned distal to the ground and active elements.

The antenna can include a substrate made from, for example, a dielectric material such as polystyrene or Teflon, which are common printed circuit board (PCB) materials. The first and second conductive elements can be positioned on opposite sides or on the same side of the substrate. The first and second elements can be made of a conductive metal, such as copper.

In some configurations, the active element receives and transmits signals having an antenna pattern with a peak gain being directed substantially along a horizon of the earth by the ground element. The peak gain can be directed at an angel of about 10° above the horizon.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A illustrates a preferred configuration of an antenna apparatus used by a mobile subscriber unit in a cellular system according to the invention.

FIG. 1B illustrates another preferred configuration of an antenna apparatus used by a mobile subscriber unit in a cellular system according to this invention.

FIG. 2A is a system level diagram for the electronics which control the antenna array of FIG. 1A.

FIG. 2B is a system level diagram for the electronics which control the antenna array of FIG. 1B.

FIG. 3A is a side view of an antenna element of the apparatus of FIG. 1.

FIG. 3B is a view from the opposite side of the antenna element of FIG. 3A.

FIG. 4 illustrates a beam directed ten degrees above the horizon by an antenna element configured according to the invention.

FIG. 5 is an alternative embodiment of an antenna element according to this invention.

FIG. 6 is another alternative embodiment of an antenna element according to this invention.

FIG. 7 is yet another alternative embodiment of an antenna element according to this invention.

FIG. 8A is a side view of another alternative embodiment of antenna element of the apparatus of FIG. 1.

FIG. 8B is a view from the opposite side of the antenna element of FIG. 8A.

FIG. 9A is a diagram illustrating a narrow bandwidth feature of the antenna element of the present invention.

FIG. 9B is a diagram illustrating a broad bandwidth feature of the antenna element of the present invention.

FIG. 9C is a diagram illustrating a multiple bandwidth feature of the antenna element of the present invention.

FIG. 10A is a perspective view of an antenna element with an active top portion and a bottom ground portion coupled to a vertical ground surface according to the invention.

FIG. 10B is a perspective view of an antenna element with an active bottom portion and a top ground portion coupled to a vertical ground surface according to the invention.

FIG. 10C is a perspective view of a choked dipole antenna element with a vertical ground surface according to the invention.

FIG. 10D is a perspective view of a dipole antenna with a conical ground surface according to the invention.

FIG. 10E is a perspective view of a dipole antenna with a cellular phone serving as a ground surface according to the invention.

### DETAILED DESCRIPTION OF THE INVENTION

A description of preferred embodiments of the invention follows. The embodiments are provided by way of example and not as limitations of the invention.

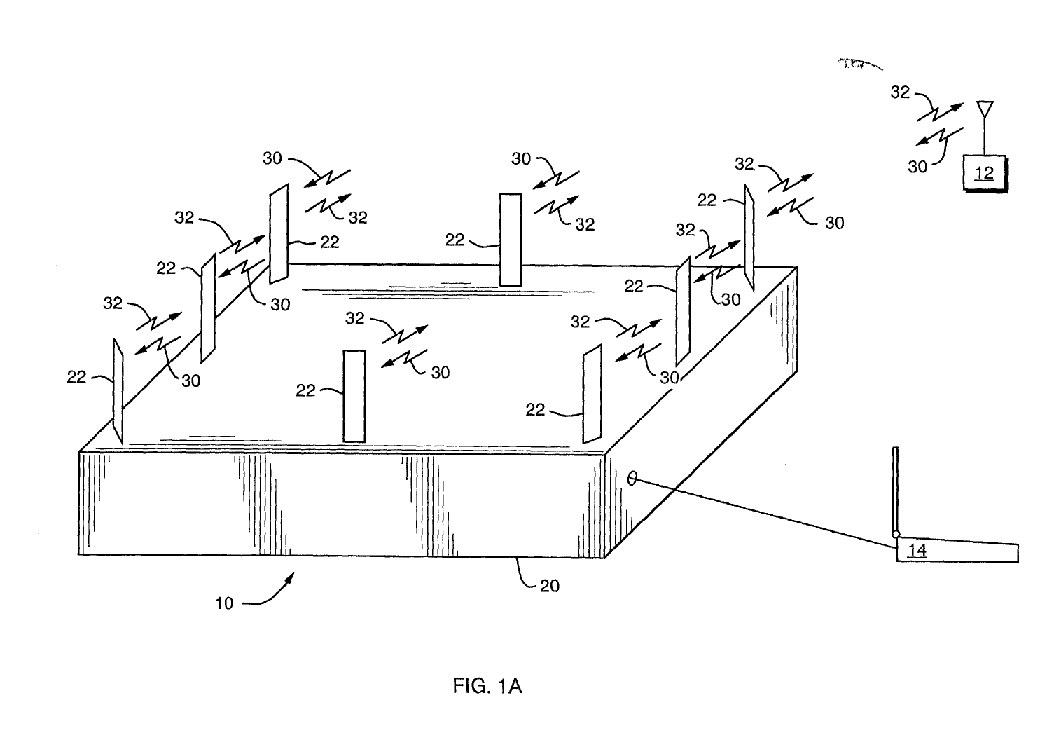

Turning now to the drawings, there is shown in FIG. 1A an antenna apparatus 10 configured according to the present invention. Antenna apparatus 10 serves as the means by which transmission and reception of radio signals is accomplished by a subscriber unit, such as a laptop computer 14 coupled to a wireless cellular modem, with a base station 12. The subscriber unit provides wireless data and/or voice services and can connect devices such as the laptop computer 14, or personal digital assistants (PDAs) or the like through the base station 12 to a network which can be a Public Switched Telephone Network (PSTN), a packet switched computer network, or other data network such as the Internet or a private intranet. The base station 12 may communicate with the network over any number of different efficient communication protocols such as primary ISDN, or even TCP/IP if the network is an Ethernet network such as the Internet. The subscriber unit may be mobile in nature and may travel from one location to another while communicating with base station 12.

It is also to be understood by those skilled in the art that FIG. 1 may be a standard cellular type communication system such as CDMA, TDMA, GSM or other systems in which the radio channels are assigned to carry data and/or voice signals between the base station 12 and the subscriber unit 14. In a preferred embodiment, FIG. 1 is a CDMA-like system, using code division multiplexing principles such as those defined in U.S. Pat. No. 6,151,332.

Antenna apparatus 10 includes a base or ground plane 20 upon which are mounted eight antenna elements 22. As illustrated, the antenna apparatus 10 is coupled to the laptop computer 14 (not drawn to scale). The antenna apparatus 10 allows the laptop computer 14 to perform wireless communications via forward link signals 30 transmitted from the base station 12 and reverse link signals 32 transmitted to the base station 12.

In a preferred embodiment, each antenna element 22 is disposed on the ground plane 20 in the dispersed manner as illustrated in the figure. That is, a preferred embodiment includes four elements which are respectively positioned at locations corresponding to corners of a square, and four additional elements, each being positioned along the sides of the square between respective corner elements.

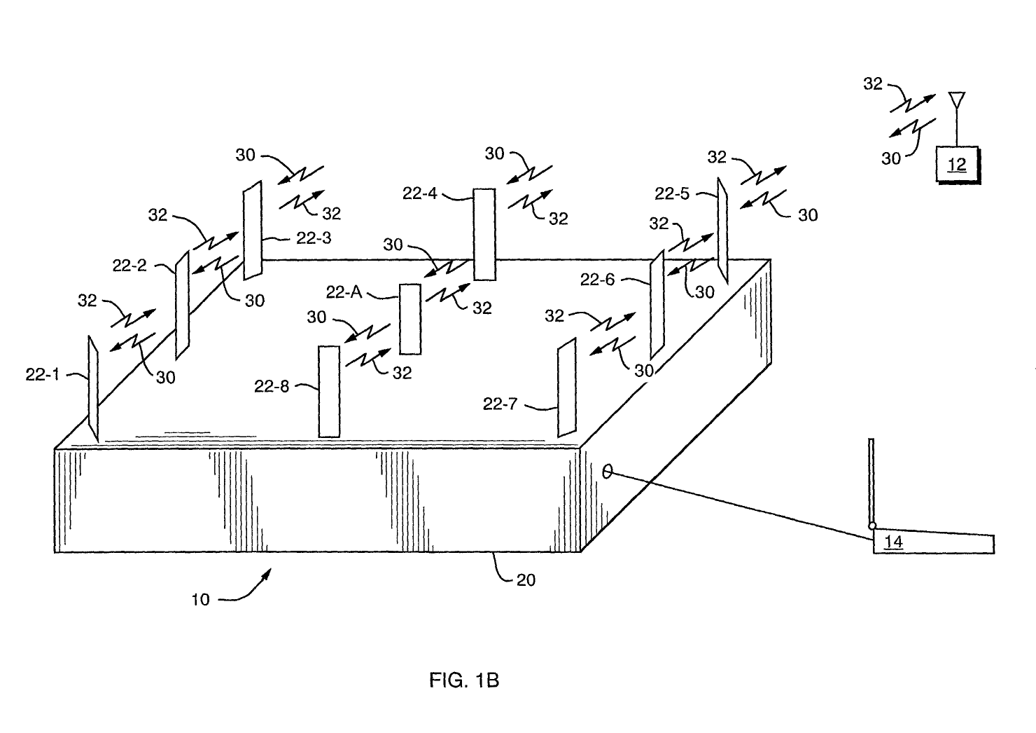

Turning attention to FIG. 2A, there is shown a block diagram of the electronics which control the subscriber access unit 11. The subscriber access unit 11 includes the antenna array 10, antenna Radio Frequency (RF) sub-assembly 40, and an electronics sub-assembly 42. Wireless signals arriving from the base station 12 are first received at the antenna array 10 which consists of the antenna elements 22-1, 22-2, . . . , 22-N. The signals arriving at each antenna element are fed to the RF subassembly 40, including, for example, a phase shifter (or an impedance element) 56, delay 58, and/or switch 59. There is an associated phase shifter 56, delay 58, and/or switch 59 associated with each antenna element 22.

The signals are then fed through a combiner divider network 60 which typically adds the energy in each signal chain providing the summed signal to the electronics sub-assembly 42.

In the transmit direction, radio frequency signals provided by the electronic sub-assembly 42 are fed to the combiner divider network 60. The signals to be transmitted follow through the signal chain, including the switch 59, delay 58, and/or phase shifter 56 to a respective one of the antenna elements 22, and from there are transmitted back towards the base station.

In the receive direction, the electronics sub-assembly 42 receives the radio signal at the duplexer filter 62 which provides the received signals to the receiver 64. The radio receiver 64 provides a demodulated signal to a decoder circuit 66 that removes the modulation coding. For example, such decoder may operate to remove Code Division Multiple Access (CDMA) type encoding which may involve the use of pseudorandom codes and/or Walsh codes to separate the various signals intended for particular subscriber units, in a manner which is known in the art. The decoded signal is then fed to a data buffering circuit 68 which then feeds the decoded signal to a data interface circuit 70. The interface circuit 70 may then provide the data signals to a typical computer interface such as may be provided by a Universal Serial Bus (USB), PCMCIA type interface, serial interface or other well-known computer interface that is compatible with the laptop computer 14. A controller 72 may receive and/or transmit messages from the data interface to and from a message interface circuit 74 to control the operation of the decoder 66, an encoder 74, the tuning of the transmitter 76 and receiver 64. This may also provide the control signals 78 associated with controlling the state of the switches 59, delays 58, and/or phase shifters 56. For example, a first set of control signals 78-3 may control the phase shifter states such that each individual phase shifter 56 imparts a particular desired phase shift to one of the signals received from or transmitted by the respective antenna element 22. This permits the steering of the entire antenna array 10 to a particular desired direction, thereby increasing the overall available data rate that may be accomplished with the equipment. For example, the access unit 11 may receive a control message from the base station commanded to steer its array to a particular direction and/or circuits associated with the receiver 64 and/or decoder 66 may provide signal strength indication to the controller 72. The controller 72 in turn, periodically sets the values for the phase shifter 56.

Referring now to FIGS. 1B and 2B, there is shown an alternative arrangement for the antenna array 10 of the access unit 11. In this configuration, a single active antenna element 22-A is positioned in the middle of the ground plane 20 and is surrounded by a set of passive antenna elements 22-1, 22-2, 22-3, . . . , 22-N. (In FIG. 1B, there is shown eight passive antenna elements.) Here only the active antenna element 22-A is connected, directly through the duplexer filter 62, to the electronics subassembly 42. An associated delay 58, variable or lumped impedance element 57, and switch 59 is connected to a respective passive antenna element 22-1, 22-2, 22-3, . . . , 22N.

In the arrangement shown in FIGS. 1B and 2B, the transmit/receive signals are communicated between the base station and the active antenna element 22-A. In turn, the active antenna element 22-A provides the signals to the electronics sub-assembly 42 or receives signals from the assembly 42. The passive antenna elements 22-1, 22-2, 223, . . . , 22-N either reflect the signals or direct the signals to the active antenna element 22-A. The controller 72 may provide control signals 78 to control the state of the delays 58, impedance elements 57, and switches 59.

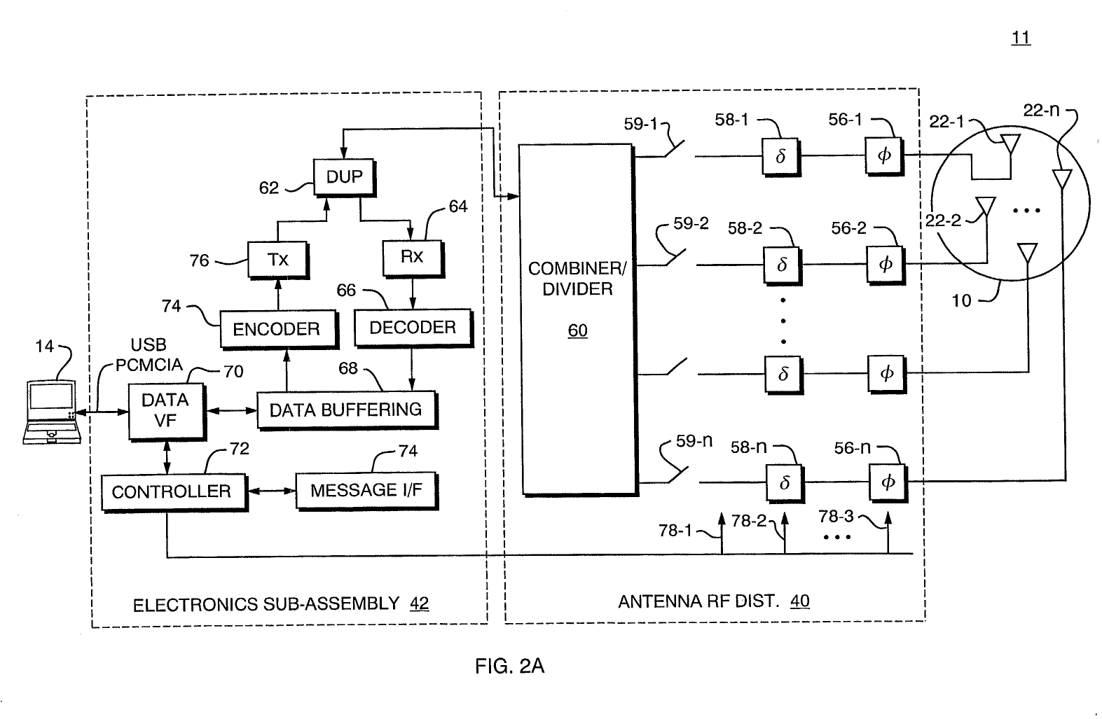

As illustrated in FIGS. 3A and 3B, each antenna element 22 includes a substrate 140 upon which a conductive planar element 142 is printed on one side 144 in a lower region of the substrate 140 and a conductive planar ground path 146 is printed on a opposite side 148 in an upper region of the substrate 140. The conductive planar element 142 includes a short feed line 150 which extends from the bottom of an enlarged square-shaped portion 151 of the conductive planar element 142 and connects to a transmission line 152 at a bottom feed point 153 located at a bottom edge 154 of the substrate 140. The conductive planar element 142 and the transmission line 152 are electrically isolated from the ground plane 20. The feed line 150 is shortened to minimized the delay from the feed point 153 to the conductive planar element 142.

When the antenna element 22 acts as a passive element, the transmission line 152 is connected to the delay line 58 which in turn is connected to the variable or lumped impedance element 57 and the switch 59. Specific capacitance values can be intentionally introduced in the feed line to the antenna so that the delay required to change the antenna from a reflective antenna to a directive antenna and vice versa can be tuned to be about one-quarter wavelength apart to maximize the useful passive bandwidth of the passive antenna element 22.

Referring now in particular to FIG. 3B, the conductive planar ground patch 146 includes an enlarged square portion 170 and is connected to a vertically strip 172 which extends from the bottom of the enlarged square portion 170 to the bottom edge 154 of the substrate 140. The vertically strip 172 couples the conductive planar ground patch 146 to the ground plane 20.

The substrate 140 is made from a dielectric material. For example, the substrate can be made from PCB materials, such as polystyrene or Teflon. For applications in the PCS bandwidth (1850 Mhz to 1990 Mhz), the substrate 140 has a length, “1,” of about 2.4 inches, a width “w,” of about 0.8 inch, and has a thickness, “t,” of about 0.031 inch. The conductive planar element 142, the vertically strip 172, and the conductive planar ground patch 146 are produced with printed circuit board techniques by depositing a respective copper layer to both sides 144 and 148 of the substrate 140 with a thickness of about 0.0015 inch, and then photoetching the copper layer into the desired shapes.

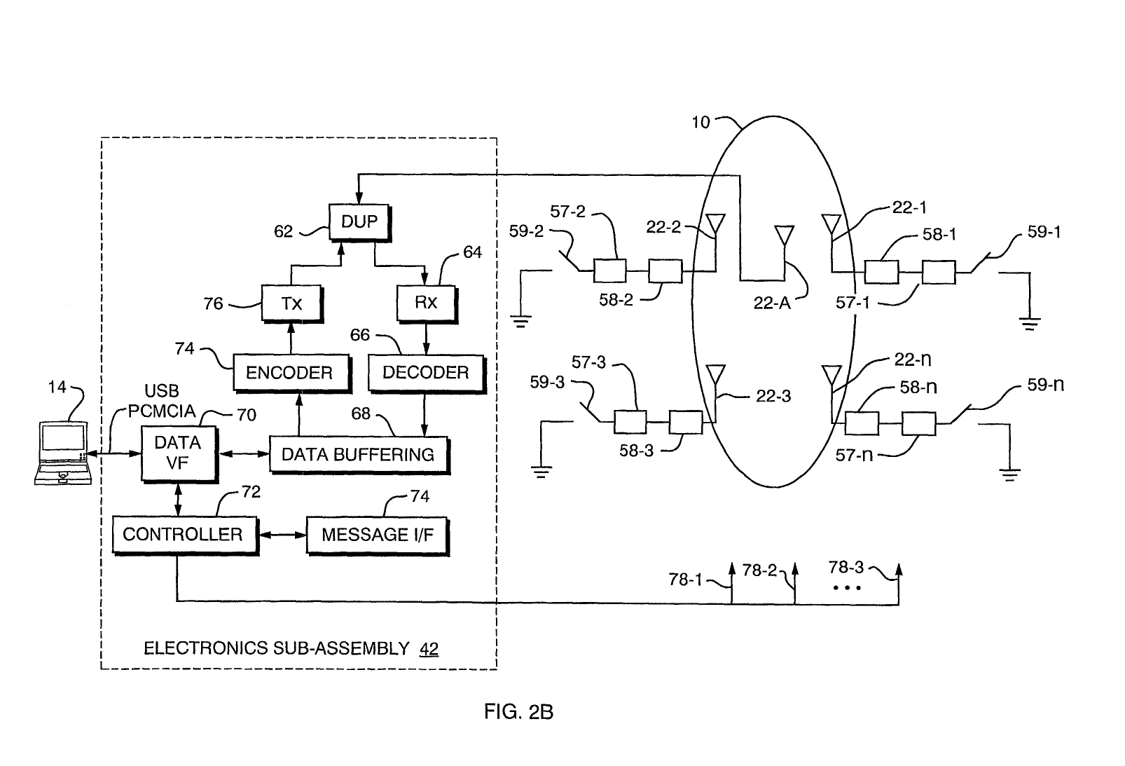

In use, the conductive planar element 142 is directly fed by the feed point 153 through the short feed line 150 such that the conductive planar element 142 acts as a monopole antenna. To meet typical bandwidth requirements, the beam formed by the conductive planar element 142 is highly ground-plane dependent. As such, without the presence of the conductive planar ground patch, the peak beam strength of the beam formed by the conductive planar element tilts about 30° above the horizon. However, in most applications the angle of incidence between the base station and the subscriber unit is about 0°. Thus, the conductive planar ground patch 146 is placed above the conductive planar element 142 to force the peak beam down along the horizon. With such a stacked arrangement, the antenna array 10 is capable of transmitting beams with peak beam strengths that rise no more than about 10° above the horizon (FIG. 4).

As mentioned above, the conductive planar element 142 is shaped as a square to maximize the bandwidth of the antenna 22. In PCS applications, the antenna element 22 resonants with a center frequency, “f_{C},” for example, of about 1.92 Ghz with a bandwidth of about 10%. The conductive planar element 142 is square shaped to further maximize the bandwidth of the antenna 22. In alternative embodiments, the conductive planar element 142 can have a non-square shape to enable the antenna element 22 to transmit at other bandwidth requirements such as dual bands or narrow single bands.

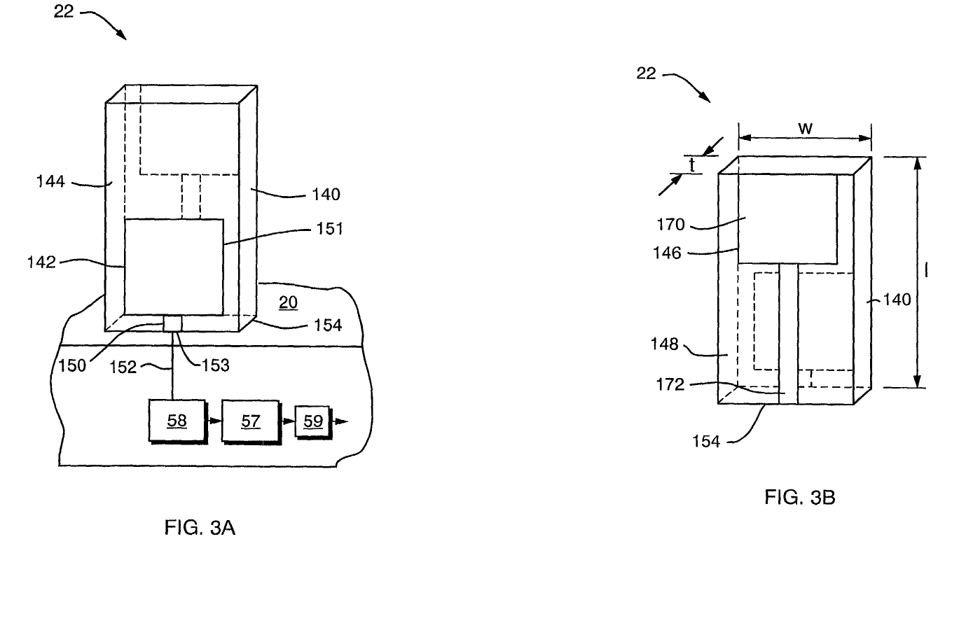

For example, referring to FIG. 5, there is shown a T-shaped conductive planar element 200. The element 200 has a vertical strip portion 202 which extends from a midsection of a horizontal strip portion 204. As with the conductive planar element 142 (FIGS. 3A and 3B), the vertical strip portion 202 terminates at a feed point 206 which is connected to a transmission feed line such as the transmission line 152.

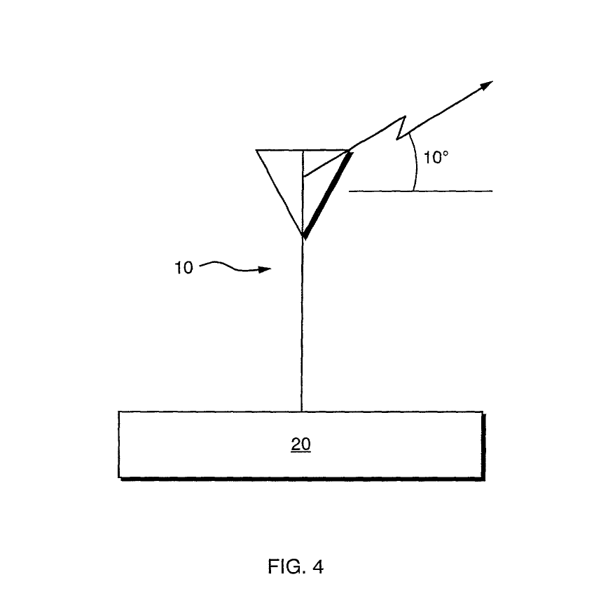

In another embodiment shown in FIG. 6, a conductive planar element 300 also has a predominantly T-shaped structure. The conductive planar element 300 includes a vertical strip portion 302 connected to a feed line at a feed point 304 located at the bottom of the planar element 300. The vertical strip portion extends to a horizontal strip portion 306. At either end of the horizontal strip portion 306 is a downward extension 308 that extends towards the bottom of the conductive planar element 300.

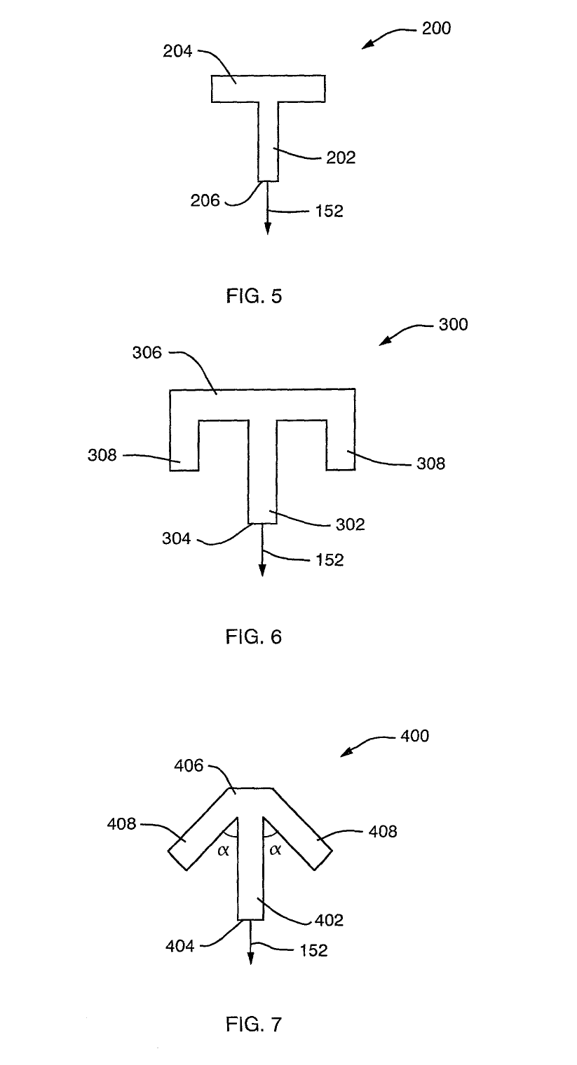

In yet another embodiment of the invention shown in FIG. 7, a conductive planar element 400 includes a vertical feed strip 402 terminating at a feed point 404 at one end and connected at the other end to the midsection of a second portion 406 of the conductive planar element 400. The second portion 406 of the conductive planar element 400 includes at either end of the second portion 406 a tapered section 408 which tilts downward from a horizontal plane towards the vertical strip 402. Each tapered section 408 and the vertical strip 402 define an angle, “α,” of about 45°.

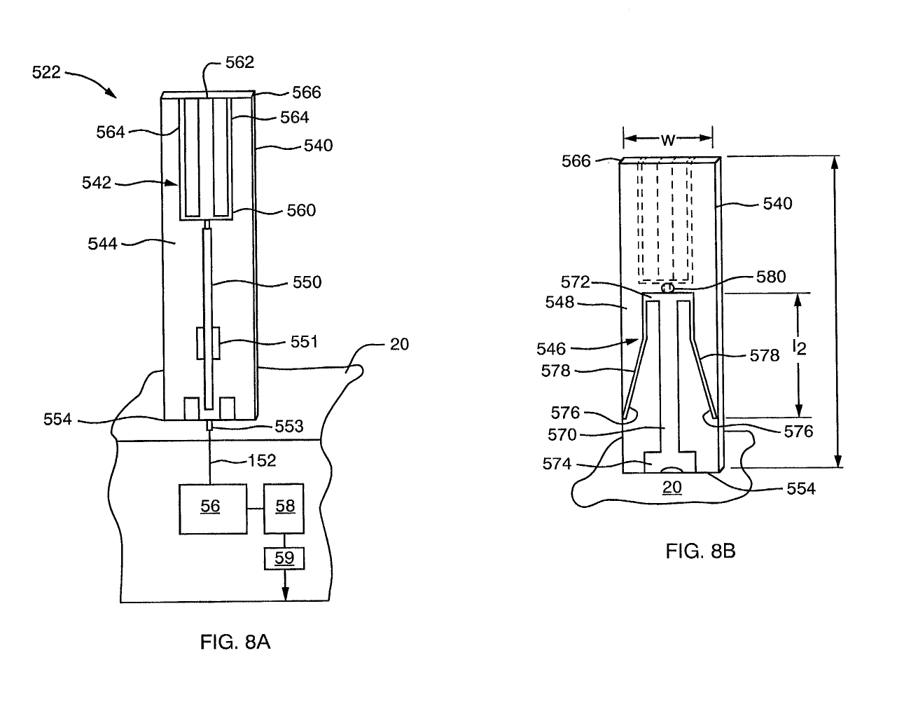

Although the embodiments discussed above were described in the context of monopole antennas, antennas functioning as dipole antennas are also within the scope of the invention. For example, referring now to FIGS. 8A and 8B, there is shown an antenna element 522 having a so-called “choked” dipole design.

Each antenna element 522 includes a substrate 540 upon which a conductive planar element 542 is printed on one side 544 in an upper region of the substrate 540 and a conductive planar ground patch 546 is printed on an opposite side 548 in a lower region of the substrate 540. A feed strip 550 extends from the bottom of the conductive planar element and connects to the transmission line 152 at a bottom feed point 553 located at a bottom edge 554 of the substrate 540. The conductive planar element 542 and the transmission line 152 are electrically isolated from the ground plane 20. The feed strip 550 includes an enlarged section 551. The size of enlarged section 551 as well as its location along the feed strip 550 can be varied to alter the impedance of the antenna element 522. Typically, the impedance of the antenna element 522 is matched with the feed impedance.

As mentioned earlier with reference to the antenna element 22, the antenna element 522, through the transmission line 152, is connected to the phase shifter (or the impedance element) 56 which in turn is connected to the delay line 58 and the switch 59. If the antenna element 522 is connected to an impedance element 56 rather than a phase shifter, the impedance element can be a variable impedance element or a lumped impedance element. The transmission line 152 provides a path for transmitted signals to and received signals from the antenna element 522. The phase shifter 56 of each antenna element 522 is independently adjustable to facilitate changing the phase of a signal transmitted from the antenna element 522.

The conductive planar element 542 includes a base 560 which is aligned perpendicularly to the feed strip 550. Extending upwards from the base 560 are a wider middle arm 562 and two narrower outer arms 564. These arms 562 and 564 extend to a top edge 566 of the substrate 540.

Referring now to the view of the opposite side of the element 522 in FIG. 8B, the conductive planar ground patch 546 includes an elongated middle portion 570 which extends from the midsection of a horizontal strip 572 to an enlarged base 574. (The profile of the conductive planar element 542 is also shown in FIG. 8B for illustrative purposes.) The enlarged base 574 is connected to the ground plane 20 to electrically couple the conductive ground patch 546 to the ground plane 20. Located on either end of the horizontal strip 572 is a downwardly extending arm 576. Each arm 576 includes a flared section 578 which flares away from the elongated middle portion 570.

The substrate 540 is made from a dielectric material. For example, the substrate 540 can be made from PCB materials such as polystyrene or Teflon. For applications in the PCS bandwidth (1850 Mhz to 1990 Mhz) the substrate has a length, “1,” of about 3.035 inches, a width, “w,” of about 0.833 inch, and is about 0.031 inch thick. The conductive planar element 542, the feed strip 550, and the conductive planar ground patch 546 are produced with printed circuit board techniques by depositing a respective copper layer to both sides 544 and 548 of the substrate 540 with a thickness of about 0.0015 inch, and then photoetching the copper into the desired shapes. A subsequent thin layer of gold, solder material, or a solder mask, with a thickness of about 0.0001 inch, is layered on top of the copper.

In use, the conductive planar element 542 is fed through the feed point 553 along the feed strip 550. However, because of capacitive coupling between the conductive planar element 542 and the conductive planar ground patch 546, there is a junction created which provides a distributed feed point 580 in a middle region of the substrate 540. Thus, even though the feed strip 550 does not directly feed the conductive planar ground patch 546, the combination of the conductive planar element 542 and the conductive planar ground patch 546 acts as an unbalanced dipole antenna being fed at the distributed feed point 580. That is, some of the energy provided to the conductive planar element 542 splits off and is fed to the arms 576 of the conductive planar ground patch 546. The sections 578 of the outer arms 576 flare away from the middle elongated portion 570 of the conductive planar ground patch 546 to prevent the resonating arms 576 from interacting or coupling with the middle elongated portion 570 which is coupled to the ground plane 20.

Because the conductive planar element 542 is located a distance from the ground plane 20 and is fed by a narrow feed strip 550 which acts as a “choke,” interactions between the conductive planar element 542 and the ground plane 20 are minimized. By doing so, the peak beam strength of the beam transmitted by the antenna element 522 is directed more towards the horizon. Like the antenna elements discussed earlier, a set of antenna elements 522 of FIGS. 8A and 8B can be configured as the antenna array 10 which is capable of forming a beam with a peak beam strength rising no more than 10° above the horizon, as depicted in FIG. 4.

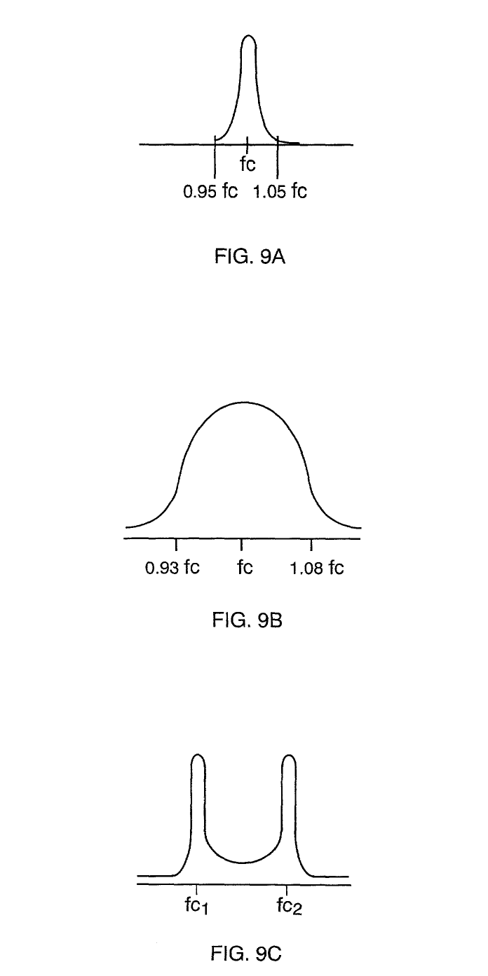

The lengths, “1₂,” of the arms 576 are equal in length to a quarter wavelength of the transmitted wave. The lengths of these arms 576 as well as the lengths of the arms 562 and 564 of the conductive planar element 542 are trimmed to modify the transmission frequency of the antenna element 522. In PCS applications, the antenna element 522 resonants with a center frequency, “f_{C},” for example of about 1.92 GHz, with a bandwidth of about 10% (FIG. 9A). Alternatively, the arms 576 of the conductive planar ground patch 546 and the middle arm 562 and the two outer arms 564 of the conductive planar element 542 can have different lengths so that the arms resonant at different frequencies. The different resonating frequencies effectively broaden the bandwidth of the antenna element 522, for example, to about 15% (FIG. 9B), or enable the antenna element 522 to resonant at two, frequencies “f_{C1},” and f_{C2}” over narrow bandwidths (FIG. 9C), or at more than two frequencies.

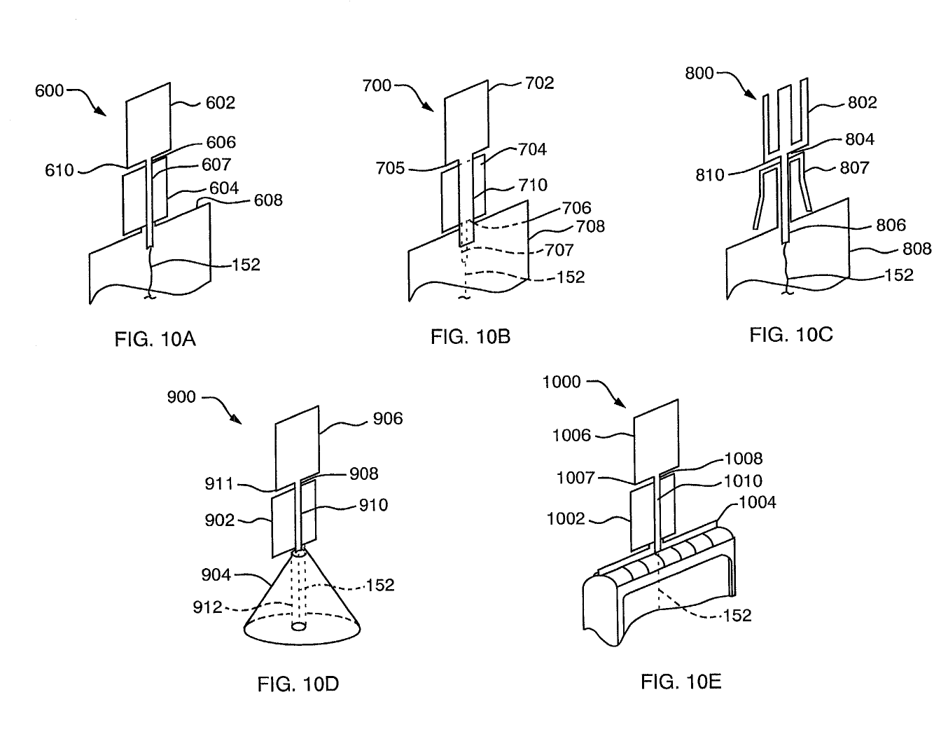

Other antenna configurations are also within the scope of the invention, such as, for example, the antenna elements illustrated in FIGS. 10A through 10E, which do not require the use of a substrate for supporting the active and ground elements. Rather, the active and ground elements are separated by an air gap.

Referring in particular to FIG. 10A, there is shown an antenna element 600 with an active element 602 positioned above a ground element 604. The active element 602 includes a center feed point 606 connected a feed strip 607 which in turn is connected to the transmission line 152, while the ground element 604 is directly coupled to a vertical ground surface 608. There is a vertical gap 610 between the active element 602 and the ground element 604. Moreover, the feed strip 607 is spaced apart from the ground element 604, and does not make physical contact with the vertical ground surface 608. Hence, the active element 602 and the ground element 604 are electrically separated by an air gap.

Turning to FIG. 10B, an antenna element 700 includes a ground element 702 positioned in an upper portion of the antenna element, and an active element 704 located beneath the ground element 702 such that the ground element 702 and the active element 704 define a vertical gap 705. In this embodiment, the active element is provided with a bottom feed 706 connected to a feed strip 707 that is connected to the transmission line 152, and the ground element 702 is coupled to a vertical ground surface 708 with a strip 710. Because the feed strip 707 is not physically connected to the ground surface 708, and the strip 710 is spaced apart from the active element 704, there is an air gap that separates the active element 704 from the ground element 702.

Referring now to FIG. 10C, there is shown an antenna element 800 having a similar configuration to the antenna element 600 depicted in FIG. 8. The antenna element 800 includes an upper active element 802 with a center feed point 804 connected to the transmission line 152 with a feed strip 806, and a lower ground element 807 coupled to a vertical ground surface 808. As with the antenna elements 600 and 700, there is a vertical gap 810 between the active element 802 and the ground element 807. Furthermore, unlike the antenna element 600 (FIG. 8), the active element 802 and the ground element 806 are separated by an air gap rather than a dielectric substrate, since the feed strip 806 is spaced apart from and does not make contact with the ground element 806.

The embodiments of the antenna elements shown in FIGS. 3 and 8 are coupled to a ground plane that is orientated orthogonal to the ground patch or ground element, while the embodiments of the antenna elements discussed with reference to FIGS. 10A-10C are coupled to vertical ground surfaces. However, any of the above discussed antenna elements illustrated in FIGS. 3, 8 and 10A-10C can be coupled to non-planar ground surfaces, as well.

For example, there is shown in FIG. 10D an antenna element 900 with a similar configuration as the antenna element 600 (FIG. 10A). Here, the antenna element 900 includes a ground element 902 coupled to a conical ground surface 904, with the apex of the conical ground surface being nearest the ground element 902, and an active element 906 positioned above the ground element 902. The active element 906 includes a center feed 908 connected to the transmission line 152 with a feed strip 910. The active element 906 and the ground element 902 define a vertical gap 911. The transmission line 152 extends through an opening 912 of the ground surface 904 without making contact with the ground surface 904. Thus, since the feed strip 910 is physically separated from the ground element 902, an air gap is provided between the active element 906 and the ground element 902.

The ground surface can be spherical or can have an arbitrary shape. By way of example, there is shown in FIG. 10E an antenna element 1000 with a ground element 1002 coupled to a cellular phone 1004. As with the antenna elements 600 (FIG. 10A) and 900 (FIG. 10D), the antenna element 1000 includes an active element 1006 positioned above the ground element 1002, with a vertical gap 1007 defined between the two elements. The active element 1006 is fed at a feed point 1008 through a feed strip 1010 that is connected to the transmission line 152 located within the cellular phone 1004.

Again the transmission feed line 152 of each of the embodiments shown in FIGS. 10A-10E is connected to a phase shifter (or the impedance element) which in turn is connected to a delay line and a switch, similar to the phase shifter 56, the delay line 58, and the switch 59, respectively, depicted in either FIG. 3 or 8. In certain configurations, if the respective antenna element is connected to an impedance element 56 rather than a phase shifter, the impedance element can be a variable impedance element or a lumped impedance element.

As described earlier, the transmission line 152 provides a path for transmitted signals to and received signals from the antenna elements 600, 700, 800, 900, and 1000, in particular, to and from the respective active elements 602, 704, 802, 906, and 1006. The phase shifter 56 of each antenna element is independently adjustable to facilitate changing the phase of a signal transmitted from the antenna element.

In the embodiments of the invention shown in FIGS. 10A-10E, the active element and ground elements are separated by an air gap. Alternatively, the active and ground elements can be positioned on the opposite sides of a substrate made of, for example, a dielectric material like that shown in FIGS. 3 and 8. Furthermore, any of the antenna elements discussed above with reference to FIGS. 3, 8, and 10 can have an active element and a ground element positioned on the same side of a substrate. Thus, PCB fabrication techniques can be used to make a coplanar waveguide structure when the active and ground elements are on the same side of the substrate, and to make a microstrip structure when the antenna element is made with the active and ground elements placed on the opposite sides of the substrate.

While this invention has been particularly shown and described with references to preferred embodiments thereof, it will be understood by those skilled in the art that various changes in form and details may be made therein without departing from the scope of the invention encompassed by the appended claims.

What is claimed is:

1. An antenna, comprising:
a first conductive element positioned in an lower region of the antenna; and
a second conductive element positioned above the first conductive element in an upper region of the antenna,
wherein one of the first and second conductive elements is an active element that transmits and receives signals, and the other element is a ground element.

2. The antenna of claim 1, wherein the first conductive element is the ground element.

3. The antenna of claim 2, wherein the second conductive element includes a center feed coupled to a feed strip for facilitating coupling the antenna to a transmission line.

4. The antenna of claim 1, wherein the second conductive element is the ground element.

5. The antenna of claim 4, wherein the first conductive element includes an end feed.

6. The antenna of claim 1, wherein the ground element is coupled a ground surface.

7. The antenna of claim 6, wherein the first conductive element is the ground element.

8. The antenna of claim 7, wherein the second conductive element includes a center feed coupled to a feed strip for facilitating coupling the antenna to a transmission line.

9. The antenna of claim 6, wherein the second conductive element is the ground element.

10. The antenna of claim 9, wherein the first conductive element includes an end feed.

11. The antenna of claim 6, wherein the ground surface is planar.

12. The antenna of claim 11, wherein the ground surface is positioned substantially parallel to the first and second conductive elements.

13. The antenna of claim 11, wherein the ground surface is positioned substantially perpendicular to the first and second conductive elements.

14. The antenna of claim 6, wherein the ground surface has a conical shape with the apex of the conical surface being positioned proximate to the ground and active elements and the base of the surface being positioned distal to the ground and active elements.

15. The antenna of claim 1, further comprising a substrate, the first and second conductive elements being positioned on the substrate.

16. The antenna of claim 15, wherein the first and second conductive elements are positioned on the same side of the substrate.

17. The antenna of claim 15, wherein the first and second conductive elements are positioned on the opposite sides of the substrate.

18. The antenna of claim 15, wherein the substrate is made of a dielectric material.

19. The antenna of claim 1, wherein the first and second elements are made of a conductive metal.

20. The antenna of claim 1, wherein the active element receives and transmits signals having an antenna pattern with a peak gain being directed substantially along a horizon of the earth by the ground element.

21. The antenna of claim 20, wherein the peak gain is directed at an angel of about 10° above the horizon.

22. The antenna of claim 1, wherein the first and second conductive elements are planar.

23. An antenna, comprising:
a substrate;
a first conductive element positioned on the substrate in an lower region of the antenna; and
a second conductive element positioned on the substrate above the first conductive element in an upper region of the antenna,
wherein one of the first and second conductive elements is an active element that transmits and receives signals, and the other element is a ground element.

24. The antenna of claim 23, wherein the active element and the ground element are positioned on opposite sides of the substrate.

25. The antenna of claim 24, wherein the first conductive element is the ground element.

26. The antenna of claim 25, wherein the second conductive element includes a center feed coupled to a feed strip for facilitating coupling the antenna to a transmission line.

27. The antenna of claim 24, wherein the second conductive element is the ground element.

28. The antenna of claim 27, wherein the first conductive element includes an end feed.

29. The antenna of claim 24, wherein the ground element is coupled a ground surface.

30. The antenna of claim 29, wherein the first conductive element is the ground element.

31. The antenna of claim 30, wherein the second conductive element includes a center feed coupled to a feed strip for facilitating coupling the antenna to a transmission line.

32. The antenna of claim 29, wherein the second conductive element is the ground element.

33. The antenna of claim 32, wherein the first conductive element includes an end feed.

34. The antenna of claim 29, wherein the ground surface is planar.

35. The antenna of claim 34, wherein the ground surface is positioned substantially parallel to the first and second conductive elements.

36. The antenna of claim 34, wherein the ground surface is positioned substantially perpendicular to the first and second conductive elements.

37. The antenna of claim 29, wherein the ground surface has a conical shape with the apex of the conical surface being positioned proximate to the ground and active elements and the base of the surface being positioned distal to the ground and active elements.

38. The antenna of claim 23, wherein the first and second elements are positioned on the same side of the substrate.

39. The antenna of claim 38, wherein the first conductive element is the ground element.

40. The antenna of claim 39, wherein the second conductive element includes a center feed coupled to a feed strip for facilitating coupling the antenna to a transmission line.

41. The antenna of claim 38, wherein the second conductive element is the ground element.

42. The antenna of claim 41, wherein the first conductive element includes an end feed.

43. The antenna of claim 38, wherein the ground element is coupled a ground surface.

44. The antenna of claim 43, wherein the first conductive element is the ground element.

45. The antenna of claim 44, wherein the second conductive element includes a center feed coupled to a feed strip for facilitating coupling the antenna to a transmission line.

46. The antenna of claim 45, wherein the second conductive element is the ground element.

47. The antenna of claim 46, wherein the first conductive element includes an end feed.

48. The antenna of claim 43, wherein the ground surface is planar.

49. The antenna of claim 48, wherein the ground surface is positioned substantially parallel to the first and second conductive elements.

50. The antenna of claim 48, wherein the ground surface is positioned substantially perpendicular to the first and second conductive elements.

51. The antenna of claim 43, wherein the ground surface has a conical shape with the apex of the conical surface being positioned proximate to the ground and active elements and the base of the surface being positioned distal to the ground and active elements.

52. The antenna of claim 23, wherein the active element receives and transmits signals having an antenna pattern with a peak gain being directed substantially along a horizon of the earth by the ground element.

53. The antenna of claim 52, wherein the peak gain is directed at an angel of about 10° above the horizon.

54. The antenna of claim 23, wherein the first and second conductive elements are planar.

55. The antenna of claim 23, wherein the substrate is made of a dielectric material.

56. The antenna of claim 23, wherein the first and second elements are made of a conductive metal.
